(19) United States
(12) Patent Application Publication
(10) Pub. No.: US 2026/0051736 A1
(43) Pub. Date: Feb. 19, 2026

(54) Innovative Electrical Panel

(71) Applicant: Michael EDward Klicpera, Incline Village, NV (US)

(72) Inventor: Michael Edward Klicpera, Incline Village, NV (US)

(21) Appl. No.: 19/197,344

(22) Filed: May 2, 2025

Related U.S. Application Data
(60) Provisional application No. 63/641,486, filed on May 2, 2024.

(51) Int. Cl. H02J 3/00; H02J 3/38; H02J 13/00

(52) U.S. Cl. CPC H02J 3/007; H02J 3/0012; H02J 3/381; H02J 13/00001; H02J 13/00004; H02J 13/00022; H02J 13/00036; H02J 2300/24; H02J 2310/12

(57) ABSTRACT

An innovative electrical panel configured to switch between solar/battery mode and power grid mode connected to a main input power source and a solar input power source, a battery input power source or any combination thereof wherein one or more standard circuit breakers or one or more custom wireless circuit breakers are configured to utilize one or more fast-switching components that are configured to alternate one or more circuit breakers between the main input power source and the solar, a battery or any combination thereof, input power source.

### RELATED U.S. APPLICATIONS

This Application claims priority from co-pending Provisional Ser. No. 63/641,486 filed on May 2, 2024, which is incorporated by reference herein in its entirety to the present application.

### FIELD OF THE INVENTION

The present invention is directed toward electrical panels for homes and corporations. More specifically, the present invention is an innovative electrical panel that can switch between solar/battery modes and power grid modes within the panel without the need of a subpanel.

### BACKGROUND OF THE INVENTION

Electrical panels with circuit breakers provide protection in electrical systems by monitoring characteristics of the electrical power supplied to loads over electrical conductors and interrupting or breaking the circuits (tripping) when fault conditions (e.g., arc faults, ground faults, and unsafe “over current” levels) are detected. Circuit breakers are typically installed in circuit breaker panels, or load centers, often in utility rooms for commercial applications and garages, outside locations and basements for residential applications.

Solar systems are becoming more common in the typical residential and corporate environment and there is a need for panels to be adapted to both grid-tie and off grid solar/battery operations. When using solar, installation generally uses a sub-panel with home or corporate circuits designated and connected to the solar panels. The problem with solar/battery installations is the solar only provides energy for about 5 hours a day with acceptable conditions. When solar energy is not available, the batteries with an inverter are used to further provide electrical energy for fixtures and appliances. However, when climatic conditions are not desirable, for example that the sky coverage with clouds, rain and snow, solar becomes much less effective and batteries suffer from limited charging.

A solar automatic transfer (“ATS”) switch is a type of self-acting switch that is specifically designed for use with grid-tied solar power system. Solar ATS are typically installed so they connect to the grid, inverter, solar battery, and the load. The solar auto transfer switch is a relatively slow acting device that uses switching mechanism to connect to a preferred source. This ensures a continuous supply of power to an electrical load, regardless of if the primary source is working or not. The solar ATS monitors the primary source which is, in this case, is the solar system storage battery. Upon detecting a low voltage, which can be programmed to a preferred value, it initiates a switching action to connect the load to the alternate source. When the primary power source is solar or grid load, the switch detects and automatically transfers the solar or grid load as the power source. A common feature of a solar power transfer switch is the provision for manual control. This is usually a switch that you rotate to select the default power source or even override the auto function. One problem with grid-tied solar systems is that they are designed to reduce the amount of power obtained from a grid and put extra power on the grid. When the grid goes down, the ATS transfer switch is generally engaged to turn off any solar power or battery to the grid. This minimizes potential electrocution for service workers attempting to fix grid lines. Because independent panels with solar capability are not designed to accommodate both grid-tied and solar power, when the grid power is off, solar power is wasted and during this period the business or home has no power available.

Another problem with typical solar panels is that in both grid-tied and off grid systems, the main panel is connected to an independent sub-panel therefore the grid-power and off grid power is separated from the main circuits. This problem can be solved by having electrical circuits that can quickly switch between grid-tied and off-grid. Solar inverters have innovative technologies that should be used to communicate to integrate and command circuits breakers. By providing switching capability in the circuit breaker, better solar capturing can be achieved.

The use of a smartphone or computer can utilize an APP to program and display data or information, can transmit control signals to the independent circuit breakers.

### SUMMARY OF THE INVENTION

The present disclosure is an innovative electrical panel that two important functions, 1) the entire electrical panel can revert from off-grid to grid-tied that is automatic, programmed or upon command; 2) the entire panel can revert from grid-tied to off-grid by automatic, programmed or upon command and when reverting from grid-tied to off-grid, and 3) each electrical circuit in the electrical panel can go from solar/battery source to grid load source automatically or upon command (utilizing a Metal-Oxide-Semiconductor Field-Effect Transistor know as MOSFET (N type MOS, P type MOS, CMOS), Junction Field Effect Transistor know as JFET (N-Channel and P-Channel), three-terminal AC switch know as TRIAC, Bipolar Junction Transistor know as BJT, Insulated Gate Bipolar Transistor known as IGBT or inverse-parallel connected Silicon Controlled Rectifiers known as SCR electrical cut-off switches, or a Relay Switch (slower) or each electrical circuit can go from grid source to solar/battery source by automatic, programmed or upon command (utilizing a MOSFET (NMOS, PMOS, CMOS), JFET, TRIAC, BJT, IGBT or inverse-parallel connected Silicon Controlled Rectifiers (SCR) as electrical fast switches or a RELAY SWITCH (slower) The electrical panel with have at least one of a solar input and at. least one of a grid load input. The electrical panel will have one or more single output for each at least one of a solar input and at least one of a grid input and a single AC output. The electrical panel can include wireless technology to display circuit position or program the circuit position to be connected to the solar or grid load using computer and smartphone.

### BRIEF DESCRIPTION OF THE DRAWINGS

The foregoing and other advantages of the invention will become apparent upon reading the following detailed description and upon reference to the drawings.

FIG. 1 is a view of a typical utility electric panel.

FIG. 2 is a perspective view of an innovative electrical panel having both grid-tied power and solar/battery power that are electrically connected in one or more single electrical panels.

FIG. 3 is a perspective view of an innovative electrical panel with switching circuit breakers.

FIG. 4 is a block diagram of an off-grid mode design of the electrical system with the innovative electrical panel with independent switch circuit breakers monitoring system starting from a solar/battery power mode to a grid-tie mode in accordance with an aspect of the disclosure.

FIG. 5 is a block diagram of the tie-grid mode design of the electric system with the innovative electrical panel with independent switch circuit breakers monitoring system starting from a grid-tie power mode to a solar/battery mode in accordance with an aspect of the disclosure.

FIG. 6 is a perspective view of an innovative electrical panel that can have the solar line and utility input lines with a neutral line can be connected with a fast action switch communicating with a CPU or microprocessor, including transfer switch and for grid-tie models includes and can be used in either embodiment described above.

FIG. 7 is a perspective view of the innovative electrical panel used in the embodiment described above and has a series of indicator displays showing the electrical connection of each circuit breaker.

FIG. 8 is a perspective view of the innovative electrical panel used in the embodiment described above and has a series buttons for manually selecting the electrical connection of each circuit breaker.

FIGS. 9a and 9b are perspective views of a programmable JFET N-Channel Junction Field Effect Transistor and P-Channel Junction Field Effect Transistor circuit component to be used as a fast switch between solar, battery and utility modes for the present invention.

FIG. 9c is a perspective view of the programmable Bipolar Junction Transistor (BJT) circuit component to be used as a fast switch between solar, battery and utility modes for the present invention.

FIGS. 10a, 10b, 10c, and 10d are perspective views of a programmable MOSFET (NMOS) circuit component to be used as a fast switch between solar, battery and utility modes for the present invention.

FIG. 11a and 11b are a perspective view of the programmable three-terminal AC switch (TRIAC) circuit component to be used as a fast switch between solar, battery and utility modes for the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF THE ILLUSTRATED EMBODIMENTS

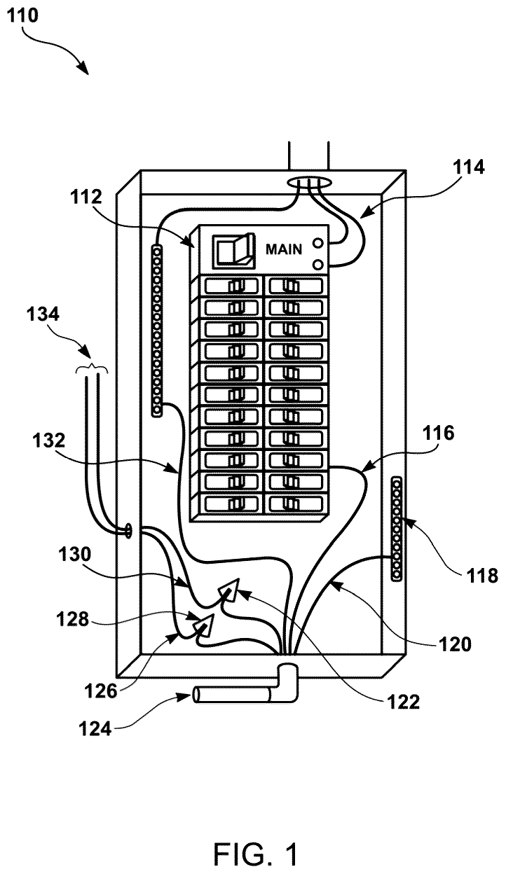

FIG. 1 shows a view of a typical old style electrical panel 110. The main power lines 114 are connected to main cut-off switch 112. The circuit panel 110 includes a plurality of circuit breakers whereby each of the circuit breakers shown is a single-pole or dual sized single circuit breaker. A grounding line 116 is connected to one of the circuit breakers. A ground plate 118 is connected to ground source 120 to ground plate. The first connector 122 and a second connector 128 are shown in the Figure. The typical electrical panel is connected to a ground conduit 124 which encompasses the neutral line 132, a first and second grounding lines 126, 130.

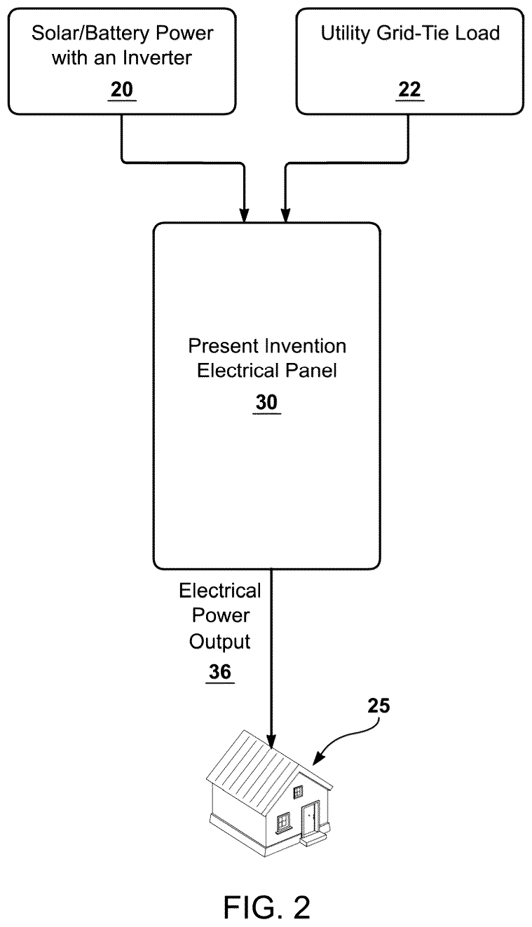

FIG. 2 show innovative electrical panel 30 that have both the solar/battery power line 30 and grid-tie load line 32 electrically connected to a single electrical panel 40. It is anticipated by the Applicant that one or more solar/battery lines can be utilized, and one or more grid-tie lines can electrically connect to an electrical panel. The only important factor is that both solar/battery line 30 and grid-tie load line 32 enter the innovative electrical panel 40. Battery power and most solar power is DC current and to enter the panel effectively an appropriately sized inverted will be necessary. Since the battery power is optional and since some solar system utilize microinverters that are connected to the solar panel directly and have split-phase power conversion capability to convert DC power to AC power efficiently, an inverter will not be necessary. One such company the makes microinverters is Enphase, which has offices in California and Texas. When the microinverter converts the DC to AC at the panel, and no batteries are being utilized with the system, no inverter is needed to be installed before the innovative electrical panel 30. Also shown in FIG. 2 is an electrical output 36 which generally are a plurality of lines the enter the residence or corporation and control an independent branch of electrical outlets, switches, and lights.

FIG. 2 also shows a perspective view of the innovative control panel 30 which has a structure that is unique in that it includes power lines for the power grid 22 and solar/battery 20. The innovative control panel 30 has one or more unique circuit breakers that are a switch that monitors the electrical current and automatically interrupts electrical flow in a circuit in case of an overload or short. The electrical power output 36 is shown providing electrical power to a residence or a corporation 25.

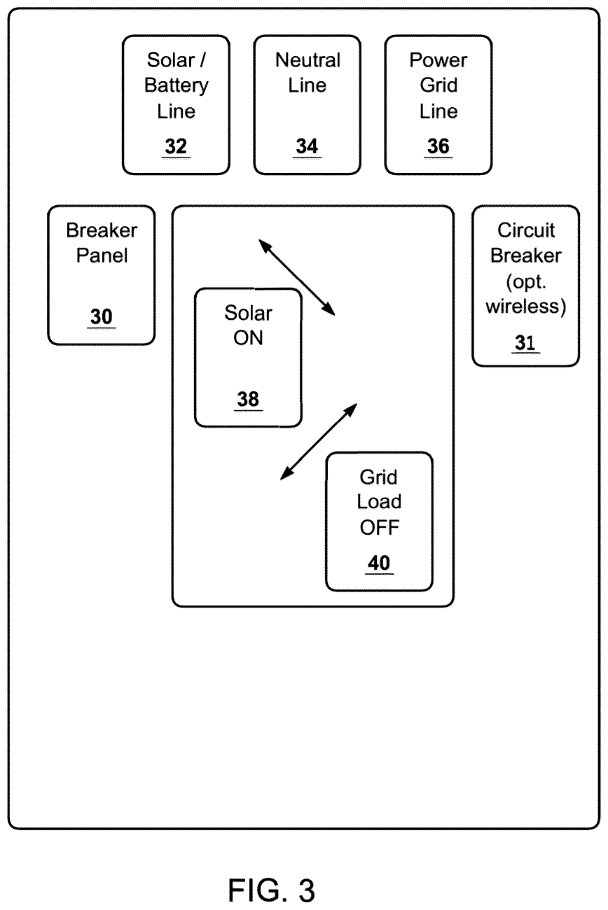

FIG. 3 shows a perspective view of the innovative control panel 30 which has a structure that is unique in that it includes power lines for the input power grid line 36, a neutral line 34 and solar/battery input line 32. The innovative control panel has one or more unique circuit breakers that are a switch that converts from a solar/battery load ON 38 and a utility grid load OFF 40. The switch is designed to convert from a solar/battery load OFF 38 and a utility grid load OFF ON (not shown). Also shown is a circuit breaker that is designed to have optional wireless capability 31

A discussion of the different types of circuit breakers that can be used with the innovative electrical panel will be necessary as there are necessary for different local or government regulations. The three main types of circuit breakers are standard, GFCI and AFCI. Some circuit breakers have dual functions that handle different amp capacities and operate in different locations of a home. Standard circuit breakers monitor the amperage capacity of the devices they operate. In the event of an overload or short circuit that is caused when a hot wire touches a neutral wire, ground wire or another hot wire. In this situation, the breaker, monitoring the heat, will interrupt the current to prevent wires from overheating and diminish the risk of electrical fires.

Standard circuit breakers are either single or double pole. Full size circuit breakers are 1-inch wide, half size circuit breakers are ½-inch wide; and twin/tandem circuit breakers are 1-inch wide with two switches and controls two circuits. Double-pole breakers occupying two slots on a breaker panel and protecting two energized lines/wires are required for large appliances such as electric dryers and electric water heaters. Ground fault circuit interrupters (GFCI) circuit breakers are required in all 125-volt, single-phase, 15- and 20-ampere receptacles in locations such as finished basements, hallways and closets, kitchens, laundry areas and bedrooms.

Are fault circuit interrupter (“AFCT”) circuit breakers protect against an unintentional electrical discharge in an electrical cord or wiring that could cause a fire. Once the AFCI breaker senses the electrical jump or an abnormal path, it instantly disconnects the damaged circuit before the arc builds enough heat to catch fire. Arcs generally occur due to worn or damaged electrical cords and wiring. Regular circuit breakers don't always trip in these instances because standard breakers are designed to respond to a sustained amount of heat, not a quick surge. Combination arc fault circuit interrupters (CAFCI) protect against the same arcs covered by AFCI as well as low-energy series arcing. They are becoming more common in homes as they protect downstream branch circuit wiring and power cords. Dual function CAFCI/GFCI circuit breaker types protect against both are faults and ground faults, which can save time and money while providing more safety than the other versions.

Besides the GFCI and AFCI capabilities, the unique circuit breaker 30 of the present invention also can be a custom-designed electrical switch that has a solar (optional battery) ON position 38 and a grid load ON position 40. It can include GFCA and AFCI technology as described above to comply with local regulations. The circuit breaker 30 can include components that can be powered by a power supply within breaker panel 30. In this embodiment, the power is supplied by obtaining electrical power from the grid line 36 and the neutral conductor 34. Optionally the custom-designed electrical switch can be a power supply that is the first priority and backed up with replaceable or re-energy or rechargeable batteries. Alternately, re-energy or rechargeable batteries can be the first priority and utilities power as the back-up power. The circuit breaker 30 can also have wireless capability that includes an energy storage device, such as a capacitor or battery, all for supplying the power for the circuit breaker be able to be tripped or moving it from solar/optional battery ON/OFF 48 position to, and from, a grid load ON/OFF position 50. The wireless circuit breaker 30 can have Bluetooth, Wi-Fi, Z-Wave or Zigbee wireless technology and communication with the CPU/Microprocessor. This allows the circuit breaker to wirelessly transmit the existence of the trip or allow the Bluetooth and Wi-Fi radios can communicate directly with and a cell phone, smart phone, and other electronic devices, within the Bluetooth or Wi-Fi range, using its Bluetooth and Wi-Fi radios to communicate using a custom programmed application (APP) to directly control the wireless circuit breaker 47 and monitor the breaker is tripped and faulted (off) or the solar/optional battery ON/OFF position or grid load ON/OFF position., along with information about the conditions that caused the trip, to the main energy monitoring CPU/microprocessor module 57 after the trip occurs or the solar/optional battery ON 48 position or grid load ON position 50 Furthermore, the wireless circuit breaker 47 can communicating the solar/optional battery ON 48 position or grid load ON position 50. In the case where microinverters, that can convert DC to AC power at the solar panel, are utilized in the solar system, the solar ON position and grid load ON at the same time. In this case, a specifically configured circuit breaker, with both solar and grid always ON (not shown) and a monitoring transfer switch must be included to disconnect the solar/optional battery power when the grid becomes disabled or goes down beyond a threshold power level. The CPU/microprocessor can have a monitoring capability that senses when the solar power fails beyond a threshold power level. Then the CPU/microprocessor can send a signal to have some or all the circuit breakers 47 to automatically turn to a solar OFF position when solar is not available. If a battery bank is utilized in the power system, the CPU can also monitor the battery bank voltage and turn the circuit breaker OFF when the battery bank voltage falls beyond a threshold power level. The wireless circuit breaker 47 can have Bluetooth, Wi-Fi, Z-Wave or Zigbee wireless technology and communication with the CPU/Microprocessor. The Bluetooth and Wi-Fi radios can communicate directly with and a cell phone, smart phone, and other electronic devices, within the Bluetooth or Wi-Fi range, using its Bluetooth and Wi-Fi radios to communicate using a custom programmed application (APP) to directly control the wireless circuit breaker 47 and monitor the breaker is tripped and faulted (off) or the solar/optional battery ON/OFF position or grid load ON/OFF position. In this embodiment, the wireless circuit breaker can be a service circuit breaker used by electronic engineers and service individuals to use the cell phone, smartphone, or another electronic device to remotely control circuit breaker. This minimizes the trips needed to travel from defective wires or areas back and forth to the circuit breaker, when done remove the wireless circuit breaker In another similar embodiment, the wireless circuit breaker has Bluetooth, Wi-Fi, Z-Wave or Zigbee wireless technology can communicate with a router, or the Wi-Fi, Z-Wave, Zigbee, LoRa, Ultra Narrow Band (UNB), or other long range low power wireless technology can communicate with a communication hub located remotely from the innovative electrical panel 40, which can be used for more complex monitoring and controlling of circuit breakers. In all wireless communications, confidential technology, such as authentication, encryption, integrity, and non-repudiation should be utilized to prevent eavesdropping and spoofing. The circuit breakers 47 can be also manually manipulated to move between a solar/optional battery ON/OFF position or a power grid ON/OFF position.

The circuit breaker can be standard type (e.g. Siemens, Schneider Electric, GE, Eaton Cutler-Hammer, Square D) can be used with the innovative electrical panel and still have wireless capability that is not built into the circuit breaker 30. In this embodiment, the standard circuit breakers, like the custom wireless circuit breakers 30, are bridged between a power grid load and a solar/battery load but a fast-acting switch can change from power grid load to a solar/battery load or from a solar/battery load to a power grid load. Wireless technology can be built into an innovative panel that can have basically the same function as the wireless technology circuit breaker 30. But custom designed circuit breakers 30 will have other capabilities that have the advantage of locating short circuits, bad neutrals, broken wires and other electrical power line problems.

The standard circuit breaker and custom wireless circuit breakers 30 can use various technologies to perform as the switching mechanism between a solar/optional battery ON/OFF position or a power grid ON/OFF position. Both the MOSFET and JFET technology can function as a high energy switch. However, there are some key differences between JFET and MOSFET. The current through JFET is channeled by the electric field that is across the reverse biased PN junction. Whereas in MOSFET, the conductivity is due to the transverse electric field in the metal-oxide insulator embedded on the semiconductor. Another key difference between MOSFET and JFET is that JFET allows less input impedance than MOSFET and since the latter which has an insulator embedded allows less leakage of current. Also, the JFET which is normally termed as “ON device” is a device that has low drain resistance while the MOSFET is termed as normally “OFF device” that can work on both depletion mode and enhanced mode and has high drain resistance.

The standard circuit breaker or custom wireless circuit breaker 30 can include monitoring of a variety of characteristics of the grid power carried on the line 22. For example, the standard circuit breaker or custom wireless circuit breaker 30 can include a monitoring of the voltage of the power on the current line current 22. To measure the voltage of the standard circuit breaker or custom wireless circuit breaker 30, a neutral line connection 34 is necessary to measure the grind line to neutral voltage. If the standard circuit breaker or custom wireless circuit breaker 30 does not need to measure voltage, then voltage measurement module can be omitted. The panel can be programmed so that the solar line voltage goes below a threshold, the circuit breakers 47 can use the switching mechanism for one or more solar/optional battery line circuit breakers in an OFF position (providing no power) so the power grid line can be turned ON and proving the power source. It is important that the one or more solar/battery with a DC power source must be off before connecting the AC power circuit breaker source as DC and AC are not compatible power sources.

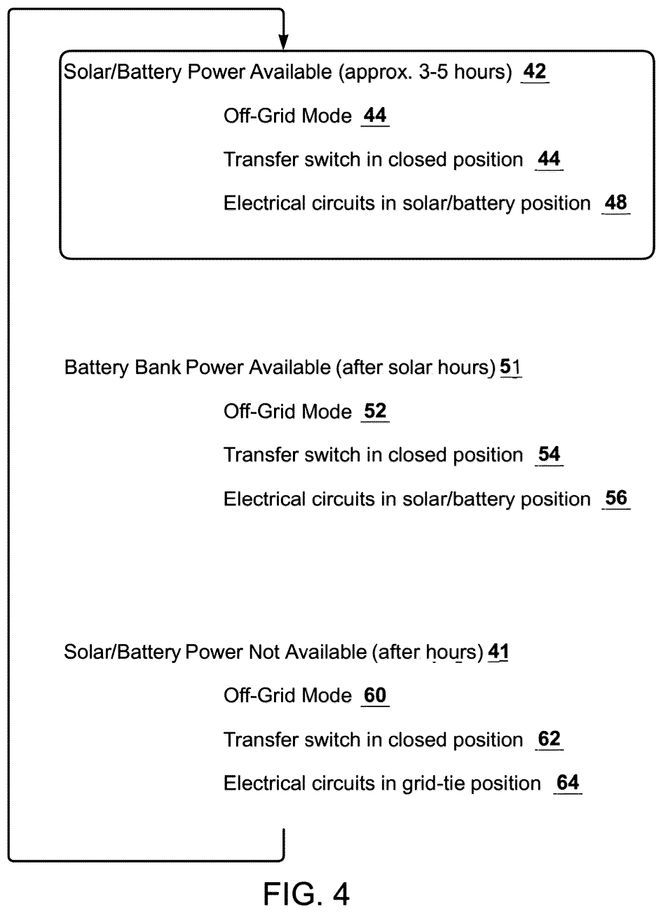

FIG. 4 is a block diagram, an off-grid mode design of the electrical system with the innovative electrical panel with independent switch circuit breakers monitoring system starting from a solar/battery power mode to a grid-tie mode in accordance with an aspect of the disclosure.

When a solar system is designed as an off-grid system, balancing the residential or corporate power needs against the solar and battery power system is important. FIG. 4 shows the off-grid sequence that shows an off-grid system that has a backup input utility grid as a power source that is necessary when the solar and battery is not sufficient, such as increased power needs after hours when it is early morning, late afternoon, nighttime when solar is not available (and the battery is depleted, or during inclement weather conditions that reduces the solar output. But this off-grid system has no connection for output power in the grid, and there is no grid-tie connection and thus, no need for a transfer switch 58. When solar or battery power is available (solar is usually available 5 hours a day) the programable off-grid mode 44 can be utilized and the transfer switch 44 is in a closed position. The selected electrical circuits are in a Solar/Battery position, and no utility power is supplied to the one or more solar/battery position using standard circuit breakers and custom wireless circuit breakers 30.

In FIG. 4 shows an off-grid mode 44, solar (3-5 hours) or battery power is available 42, the transfer switch is in a closed position 44, and the electrical circuits are in the solar/battery position 48 are being powered by the solar (or battery) 48. In the second sequence box, the system is still in an off-grid mode 52 and the battery power 51 is powered by the battery bank (or limited solar) and the transfer switch is again in a closed position. The selected electrical circuits are in a solar/battery position and no utility power is supplied to the one or more solar/battery position using standard circuit breaker and custom wireless circuit breakers 30. In the third sequence box, the solar is not producing any power and the battery is becoming depleted below a define voltage 41, and the innovative panel converts the fast transfer switches 38 (MOSFET (NMOS, PMOS, CMOS), JFET (N-channel and P-channel), TRIAC, BJT, IGBT or inverse-parallel connected Silicon Controlled Rectifiers (SCR) to a utility position 40. Then all electrical circuits are in the utility electrical source mode.

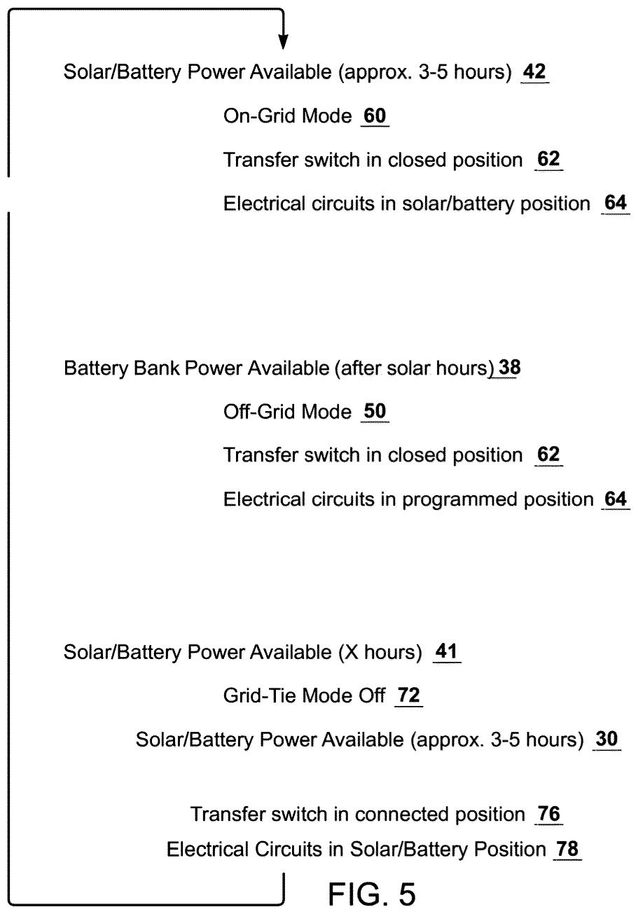

FIG. 5 is a block diagram of the innovative electrical panel with an independent switch circuit breakers monitoring system starting from a grid-tie power mode to a solar/battery mode in accordance with an aspect of the disclosure. FIG. 5 shows a solar electrical design system that is in a grid-tie mode 60. In the first sequence box, solar (3-5 hours) or battery power is available 42, the transfer switch is in a closed position 62, and the electrical circuits are in the solar/battery position 64 are being powered by the solar (or battery) 42. In the second sequence box, the system is still in an off-grid mode 50 and the battery power is powered by the battery bank 38 (or limited solar) and the transfer switch is again in a closed position 64. The selected electrical circuits are in the programmed position and no utility power is supplied to the one or more solar/battery position using standard circuit breakers and custom wireless circuit breakers 30. In the third sequence box, the solar is not producing any power and the battery is depleted below a define voltage 41, and the innovative panel switches programmed fast transfer switches 38 (MOSFET (NMOS, PMOS, CMOS), JFET (N-channel and P-channel), TRIAC, BJT, IGBT or inverse-parallel connected Silicon Controlled Rectifiers (SCR) to a utility position 40. Then all electrical circuits are in the solar/battery electrical source mode, the battery is fully charged, and the excess electrical energy is transferring to the grid with transfer switch in the connected position 76.

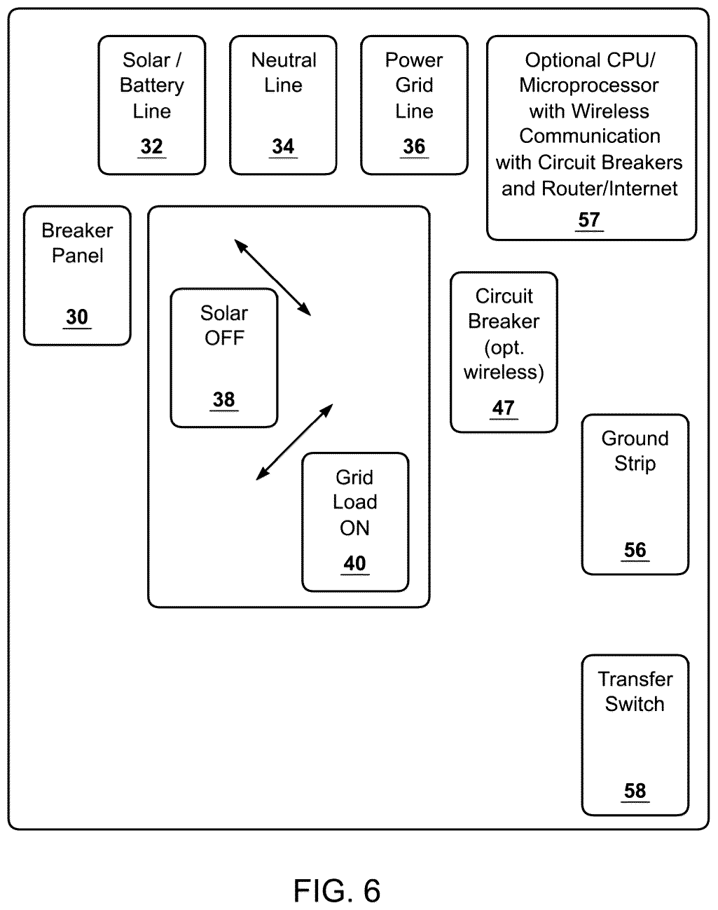

FIG. 6 is a perspective view of an innovative electrical panel that can have the solar line and utility input lines that can be connected with a fast action switch communicating with a CPU, Switch and for grid-tie models include the transfer switch and can be used in either embodiment described above.

With further reference to FIG. 6 the CPU/Microprocessor 57 module can receive from standard circuit breaker or custom wireless circuit breaker 30 the voltage or magnitude of the current in each branch circuit and any alarms, such as tripping events. The CPU/Microprocessor 57 can estimate the power in each branch circuit based on the magnitude of the voltage by monitoring each circuit breaker 47 the voltage received from the circuit breaker 47 and the magnitude of the branch current (sensed at each branch circuit by the circuit breakers). The CPU/Microprocessor module 57 can include the possibility of computing the root mean square (RMS) which is the current/voltage of the alternating current/voltage, RMS current, and estimated real power for each branch and for the system. The CPU/Microprocessor 57 can also generate alarms for circuit breakers that have tripped and can predict faults, for example by detecting near thermal trip conditions from the collected data. The CPU/Microprocessor 57 can also store a history of the data it receives and computes or transfer this information over the internet to a remote computer, cloud service or corporate network. The CPU/Microprocessor 57 can also store in the memory a history of tripping events and near-tripping events for each of the branch circuits.

The CPU or microprocessor is configured to have primary function that controls the fast-switching components 38, 40 from the utility grid mode to a solar/battery mode and vise versa. Since solar usually only lasts for 5-8 hours per day, the microprocessor can be programmed to select a one or more standard circuit breaker or custom wireless circuit breakers 30 to be in solar mode for these 5 hours. In this method, the CPU microprocessor must have a electrical switch the separate the solar power from battery power. Then, battery power can be conserved and used as a backup power source when utility is not available. Alternatively, the grid power load, the solar power load and the battery power load can follow the programmed instruction for the SUB, SBU or USB modes describe herein.

The CPU/microprocessor monitoring module 57 includes software instructions for evaluating the information communicated with one or more branches of circuits received wirelessly from the wireless circuit breakers. The main energy monitoring module includes a gateway for interfacing with other applications, such as webpages and smartphones, The innovative electrical panel can be programmed by a customer or electrician using webpages and smartphones APPs. Further, the customer or electrician can obtain information including the existence and circumstances of a spontaneous trip can be collected and sent directly to a customer or electrician using webpages and smartphones APPs.

The CPU/Microprocessor monitoring module 57 can be programmed with instructions to switch between an off-grid or in grid-tied mode. And power energy for both should have solar, utility and battery balanced for efficient uses. To offset the some off-grid mode disadvantages that require more energy balance, and for other combination of solar and utility panels and subpanels, being able to be programmed, controlled and/or manually modifying the solar power and utility power independently during an hourly, daily, weekly, monthly or yearly basis that allows for the best efficiency uses.

The power sources can be also programmed to also be used or biased towards either independently, or in combination, with Solar, Utility and Battery energy sources. For example, in a USB mode, the AC input or utility will provide power to the loads as first priority. If there is excess solar power beyond what is required for battery charging, this power is used to supply power to the loads instead of utility load.

Or the SBU mode wherein the Solar and battery will provide power to the loads as the first priority. This also allows power to the loads to be supplied when AC input/utility power is unavailable (off-grid mode). Off-grid mode needs more attention to balance with the solar input, the home or corporate energy use, and the appropriate battery source. SBU solar and battery are both used for the first priority energy source, or solar power is the first load priority. If solar power is not sufficient to power all connected loads, the battery will supplant the power to the load. The Any-Grid is currently disconnected from the grid (off-grid mode). AC input/utility provides power to the loads (grid-tied mode) only when the battery voltage drops to either low-level warning voltage or the setting point in settings menu.

SUB mode uses solar and utility that combines with the battery source for priority energy uses, SBU mode uses solar and battery for priority energy uses, and USB mode uses utility combined with solar power. Solar provides power to the loads as first priority. If solar power is not sufficient to power all connected loads, AC input/utility power will supply the loads simultaneously (grid-tied mode). If no solar power is available (ex. at night), AC input/utility power is used exclusively. The battery is only discharged when the AC input/utility power is unavailable (off-grid mode). When first applying SBU priority, it may take up to a few minutes for the grid-tie mode and switch to off-grid mode. Further, a daily, weekly, monthly or yearly calendar can be programmed to change the SUB, SBU or USB mode.

The innovative electrical panel 30 has a typical grounding strip 56 that is properly connected to code required ground source, When the power system is grid-tied an automatic transfer switch (“ATS”) 58 will be required. The automatic transfer switch 58 uses monitoring electronics and a switching mechanism to disconnect an electrical source. This will ensure a continuous supply of power to an electrical load, regardless of whether the utility source is working or not. The ATS 58 monitors the primary source which is, in this case, is the solar system and optional battery bank. Upon detecting a low voltage (which can be programmed as preferred value) it initiates a switching action to connect the load to the alternate source. When the primary power source (grid power) is back to normal, ATS 58 detects the return and automatically transfers the load to it. As already indicated, an ATS 58 for solar power systems may allow users to program its operation mode. For example, you may be able to set the minimum voltage that should cause a load to perform a changeover. Another common feature of a solar power transfer switch is the provision for manual control. This is usually a rotation switch that you rotate to select the default power source or even override the automatic functions.

An open transition transfer switch is referred to as a break-before-make transfer switch. A break-before-make transfer switch breaks contact with one source of power before it contacts another power source. It prevents back feeding and potential damage from an emergency generator back or solar panels into the utility line. One example is an open transition automatic transfer switch (ATS). During the split second of the power transfer the flow of electricity is interrupted. Another example is a manual three position switch or circuit breaker, with utility power on one side, the generator or solar power sources on the other, and “off” in the middle, which requires the user to switch through the full disconnect “off” position before making the next connection.

A closed transition transfer switch (CTTS) is also called a make-before-break transfer switch. A typical emergency system uses open transition, so there is an inherent momentary interruption of power to the load when it is transferred from one available source to another. In most cases the outage is electrically inconsequential, when the interruption is less than ⅙ of a second. However, there are some power loads that are affected by even the slightest loss of power. There are also operational conditions where it may be desirable to transfer loads with zero interruption of power when conditions permit. The switch will operate in a make-before-break mode provided both sources are acceptable and synchronized. Typical parameters determining synchronization are voltage differences less than 5%, frequency difference less than 0.2 Hz, and maximum phase angle between the sources of 5 degrees. It is generally required that the closed transition, or overlap time, be less than 100 milliseconds. If either source is not present or not acceptable (such as when normal power fails) the switch must operate in a break-before-make mode (standard open transition operation) to ensure no back feeding occurs. Closed transition transfer makes code-mandated monthly testing less objectionable because it eliminates the interruption to critical loads which occur during traditional open transition transfer. Typical load switching applications for which closed transition transfer is desirable include data processing and electronic loads, certain motor and transformer loads, load curtailment systems, or anywhere load interruptions of even the shortest duration are objectionable. A CTTS is not a substitute for a uninterruptible power supply (UPS); a UPS has a built-in stored energy that provides power for a prescribed period in the event of a power failure. A CTTS by itself simply assures there will be no momentary loss of power when the load is transferred from one live power source to another live power source.

A soft-loading transfer switch (SLTS) makes use of a CTTS and is commonly used to synchronize and operate onsite generation in parallel with utility power, and to transfer loads between the two sources while minimizing voltage or frequency transients. Homes with standby generators may use a transfer switch for a few circuits or the whole home. Different models are available, with both manual and automatic transfer. Often small transfer switch systems. use circuit breakers with an external operating linkage as the switching mechanism. The linkage operates two circuit breakers in tandem, closing one while opening the other. Manufacturers of transfer switches can provide installation guides to select the size of switches and provide recommended installation procedures.

The CPU or microprocessor electrical circuitry can be configured to include a transceiver to communicate wirelessly with one or more remote computer or an electronic communication device to: 1) program the CPU or microprocessor instructions for selecting the circuit breakers to alternate between the utility power source and the solar or battery power source, 2) to program a schedule or time when the circuit breakers are to alternate between the utility power source and the solar or battery power source and 3) to transfer electronic readings, circuit heath, solar or battery alerts, and electrical problems wirelessly to one or more remote computer or an electronic communication device. The transceiver can communication with one or more wireless communication transceivers, at least one of the one or more wireless communication transceivers are configured to communicate via a wireless network protocol based on an IEEE 802.11 standard (Wi-Fi version 3/4/5/6/6e and WiFi7); an infrared light transmission scheme (LiFi); a low power and long-range chirp spread modulation technology (LoRa); a network that utilizes the low power and long-range chirp spread modulation technology (LoRaWAN); a wireless technology that transmits over a very narrow spectrum (UNB); an Internet Protocol (IPv6) utilizing a sub-1 GHz frequency (6LowPAN); a network based on a star topology network with master and slave devices described in the EN 13757 standard, which comprises operating modes S, T, R, and C (868 MHz), F (433 MHz), and W (169 MHz) (M-Bus); a narrowband internet of things (IoT) is a low-power wide-area network radio technology standard developed by 3GPP for cellular network devices and services (NB-IoT); a differential binary phase-shift keying and Gaussian frequency shift keying over the short-range device band of 868 MHz in Europe, and the Industrial, Scientific and Medical radio band of 902 MHz in the US (Sigfox); an interoperable implementation of an IEEE 802.16 family of wireless-networks standards (WiMAX); a network that uses a smart speaker technology, provides cloud connectivity for an internet of things (IoT) and utilizes low-bandwidth and long-range connectivity (Amazon Sidewalk); a third-generation wireless mobile telecommunications technology (3G); a fourth-generation wireless mobile telecommunications technology(4G); a fifth-generation wireless mobile telecommunications technology (5G); a sixth-generation wireless mobile telecommunications technology (6G); or a seventh-generation wireless mobile telecommunications technology (7G).

To accommodate the transfer of electrical information for remote computer access and electronic communication devices, e.g. smartphone APPS, the following remote components manage the main elements of the remote computer service, but this is only exemplary and is not so limited. Several of the components defined and described can be replaced by a newly design operation(s), combine operations, or eliminate some operation(s). Professional companies, such as Amazon Web Services, handle most if not all of, the OSS and BSS services, database access, connectivity and database maintenance (e.g., SQL databases like MySQL, MariaSQL, and Aurora, Redshift, and non-SQL databases like Dynamodb), server component access and maintenance and load balancing, all for a cost base on various factors. Data access by cell phones, mobile phones, and similar apparatus 400, and remote computers can access the commercial database using certain protocols.

There are large cloud-computing companies with several computer server farms around the world that supplant the independent comprehensive internet infrastructure and communication network. Companies like Amazon®, Microsoft®, Oracle® and Google® have all built a significant quantity of computing infrastructure. Their data centers are vastly bigger, and significantly more efficient, than those operated by or could be built by most other independent companies. The cloud-computing companies with their worldwide server farms allow for scalable and redundant data storage capabilities (Redundant Array of Independent Disks or RAID technology). Large cloud-computer companies can temporarily extend or customize the functionality for a client by transferring logic to it that it can execute. Examples of this may include compiled components such as Java applets and client-side scripts such as JavaScript. Complying with these constraints and thus conforming to the REST architectural style (REST an acronym for REpresentational State Transfer), which will enable any kind of distributed hypermedia system to have desirable emergent properties, such as performance, scalability, simplicity, modifiability, visibility, portability, and reliability (RestAPI). These large companies are presently marketing and renting out their computing capacity to developers and companies around the world. The developer or company doesn't have to incur the capital expense associated with designing network connectivity system, employing various Information technology (IT) professionals, purchasing the necessary computers and servers, developing the custom and non-custom software, and conducting the significant maintenance procedures.

A programmer/developer or a company simply pays for cloud-computing services. Using the cloud-computing services provide the developer and company access to fundamentally unlimited computing power marketed by the cloud computing companies without must incur the expenses for developing and maintaining a private or corporate computer infrastructure.

There are various services, divided into certain categories, which are provided by the cloud computing companies. Infrastructure as a Service, or “IaaS,” is the most basic layer of cloud computing. It provides customers with virtual servers and database storage and Internet of Things (IoT) sensor communication and access. Platform as a Service, or “PaaS,” which is the set of application tools and services that make it easier for developers and IT professionals to build applications without the capital expense of purchasing software for application development. Software as a Service, or SaaS, which refers to applications that run in the cloud like Microsoft's Office 365, Google's G Suite and Salesforce's products for sales and marketing.

The plan for cloud-computing companies is to make their services indispensable to both independent software developers and small, medium, and large companies. Customers might venture into cloud computing with a single software application (APP) but as their businesses grow, their cloud-computer needs increase and the cloud-computing service companies are expecting that their cloud usage and revenue will increase. Amazon® has increased their presence in the cloud industry, by sacrificing short-term profits to enhance customer experience and maximize long-term gain. The more customers a cloud platform provider contracts with, the more servers and serving farms under their control can be developed. And the more servers the cloud-computing companies have, the better they can take advantage of economics of scale and offer customers lower prices for more robust features, including appeal to large enterprises. The efforts to market cloud-computing services support the idea that the near future of internet infrastructures and communication networks will be increasingly controlled and maintained by the large cloud-computing companies.

Specific communication protocols are becoming important to interface between the cloud-computing companies and the company's local or cloud database for computer, cell phone, smart phone and similar apparatus, smart internet TVs, smart central hub listening and speaker devices, and home control systems, access to acquire requested data (e.g. SQL database requests) and perform instructional activities (turn on/off water). Of these protocols, the Representational state transfer or RestAPI (or REST API), SOAP APL, Java API or XML API seem to be appropriate.

Once a user sets up a service, an activation application delivers a first display to the user on either a display means of the computer, cell phone, smart phone, mobile phone or similar apparatus 400, computer, cell phone, smart phone and similar apparatus, smart internet TVs, smart central hub listening and speaker devices, and home control systems, on the water meter and leak detection system 200 and/or on a display means on the remote devices 480. This pairing of technology or other application secure means associates a new user with a purchased or installed remote device and the water meter and leak detection system 10, 126, 200.

Electrical appliance manufacturers can also use collected information in databases transfer by the main energy monitoring module 57 to assess the health of an appliance connected to a branch circuit. For example, the main energy monitoring module 57 can record the characteristics of electrical usage on the appliance's branch and effectively learn the “signature” of the appliance's electrical use. The main energy monitoring module 57 can detect when the electrical usage on that branch changes can alert the consumer or appliance manufacturer of potential damage to the appliance. The information collected and processed by the main energy monitoring module 57 can also be used to track the energy usage on branch circuits to help a consumer understand where he or she is using electricity and how the consumer could reduce energy usage and save money,

Several applications provided by the large cloud-computing companies ensure overall management of the computer infrastructure and network service. These pre-defined applications are configured to offer off-the-shelf programs and operating systems solutions management of the integrated cloud-computing system service, overall service monitoring, customer support, and reporting.

The advantages of a main energy monitoring module and its ability to process and distribute branch circuit data can be realized without installing an entirely new panel. Instead, wireless circuit breakers in accordance with this disclosure can be installed in place of existing traditional circuit breakers in an existing panel with little or no additional equipment or labor. Additionally wireless functionality is included in the same package as the existing circuit breakers. Thus, the wireless circuit breakers can serve as direct replacements for the existing traditional circuit breakers, without the need for additional wiring. This saves space within the panel. It also allows retrofitting wireless circuit breakers without replacing the entire panel and also permits a staged approach to replacing breakers, where selective branch circuits can be retrofitted with wireless circuit breakers while others continue to use existing circuit breakers.

The wireless circuit breakers with stored energy for a period after a trip occurs, valuable information about the trip, including the state of the branch circuit current prior trip, can be saved and transmitted to the main module for analysis. The main module can then determine not only that a trip occurred, but also why the trip occurred. The main module can also distribute this information directly to a remote computer, cell or smart phone, web portal or cloud service provider.

The entire panel can revert from off-grid to on-grid automatically or upon local or remote command. The automatically mode can monitor solar voltage and amps or timing during solar hours for changing from off-grid to on-grid. The entire panel can revert from on-grid to off-grid automatically or upon local or remote command. The automatically mode can monitor solar voltage and amps or timing during solar hours for changing from on-grid to off-grid. Each Electrical Circuit can go from Solar/Battery Source to Grid Source automatically or upon command (MOSFET, JFET, TRIAC, double SCR or RELAY SWITCH (slower). Or relatival, each Electrical Circuit can go from Grid Source to Solar/Battery Source automatically or upon command (MOSFET, JFET, TRIAC, double SCR or RELAY SWITCH (slower). The main power energy panel has a solar input and grid input with a single output to the electrical lines with a home, facility or structure.

Also, optional power such as one or more batteries or electrical connection to the main power source in the present invention circuit breaker panel can be utilized for wireless circuits and transfer switches.

The present invention can include wireless technology to show or program on local or remote computer and smartphone. The wireless technology can be Bluetooth, Wi-Fi, Wi-Fi 3/4/5/6/7. Li-Fi, LoRa, Sigfox, Ultra Narrow Band (UNB), 6LowPAN, NB-IoT, M-Bus, WIMAX, Amazon Sidewalk, 3GPP cellular, 4G cellular or 5G cellular technology, Wireless technology can provide a means to activate a circuit breaker with wireless communication that can control the fault state and monitor information to a main power energy panel. A wireless transceiver is integrated inside the housing of a circuit breaker electrical coupled to a controller in the circuit breaker. The wireless circuit breaker produces power supply from the line current through the use of a current transformer surrounding the conductor, without the need for a connection to a neutral conductor.

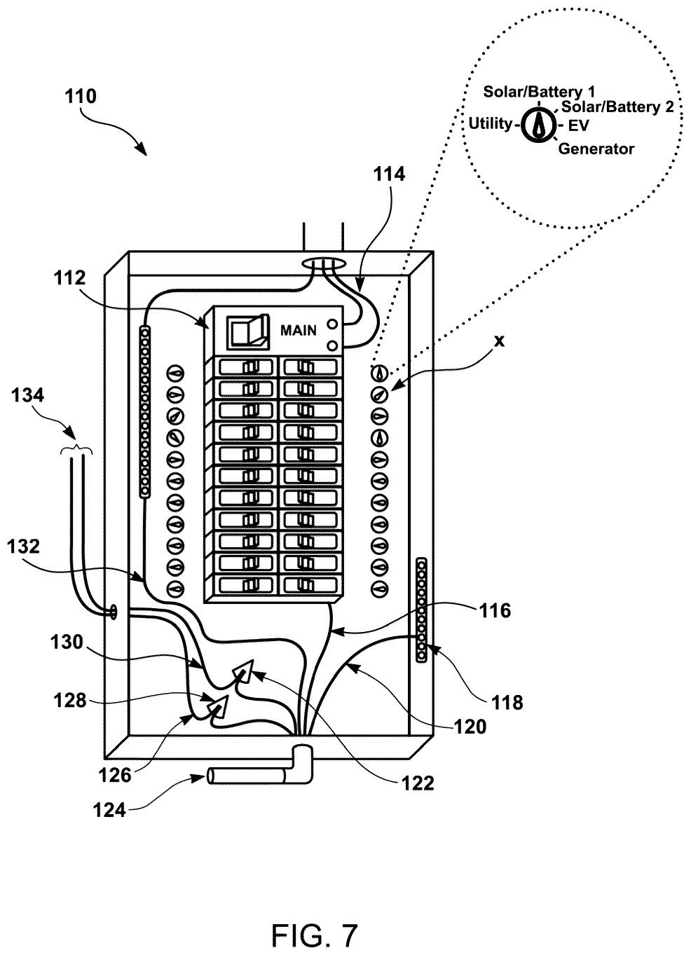

FIG. 7 is a perspective view of the innovative electrical panel used in the embodiment described above and has a series of indicator displays showing the electrical connection of each circuit breaker. For general use and safety, the innovative electrical panel can be designed with a display that shows what electrical source that is supplying electricity to the circuit breaker Shown is an indication method that shows that the circuit breaker is being powered by utility power, solar/battery power 1 and optionally solar battery power 2, a generator source, or an electric vehicle power source.

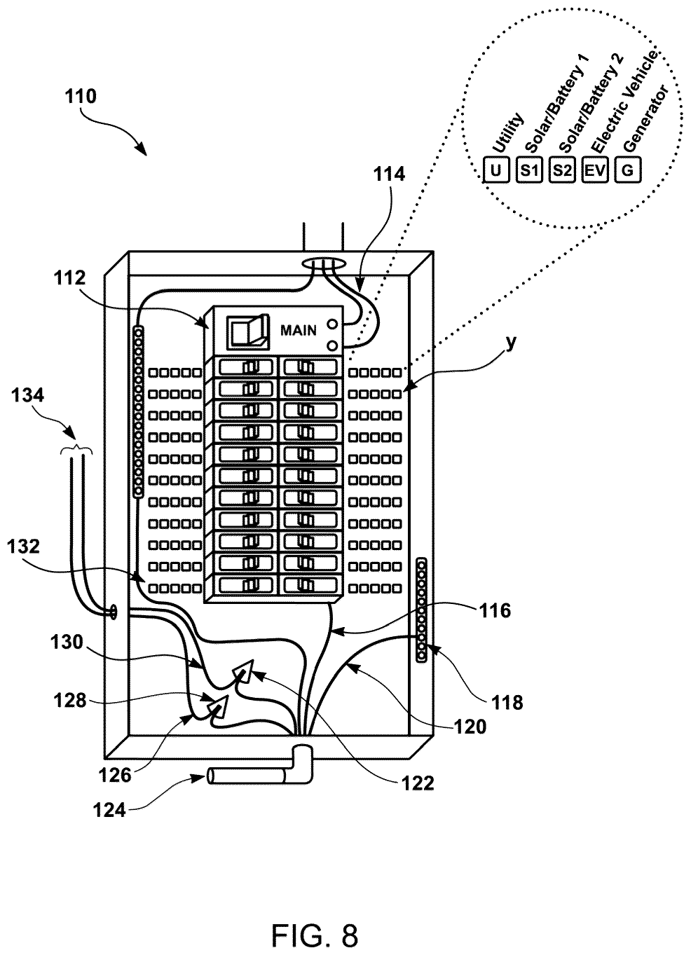

FIG. 8 is a perspective view of the innovative electrical panel used in the embodiment described above and has a series buttons for manually selecting the electrical connection of each circuit breaker. For general use and safety, the innovative electrical panel can be designed with a button array that allows a user or service professional to manually select the circuit breaker is being powered by utility power, solar/battery power 1 and optionally solar battery power 2, a generator source, or an electric vehicle power source. This manual selection will generally be used to override the programmed instructions encoded into the CPU or microprocessor. The buttons will have springs that only let one button be pressed one of a time.

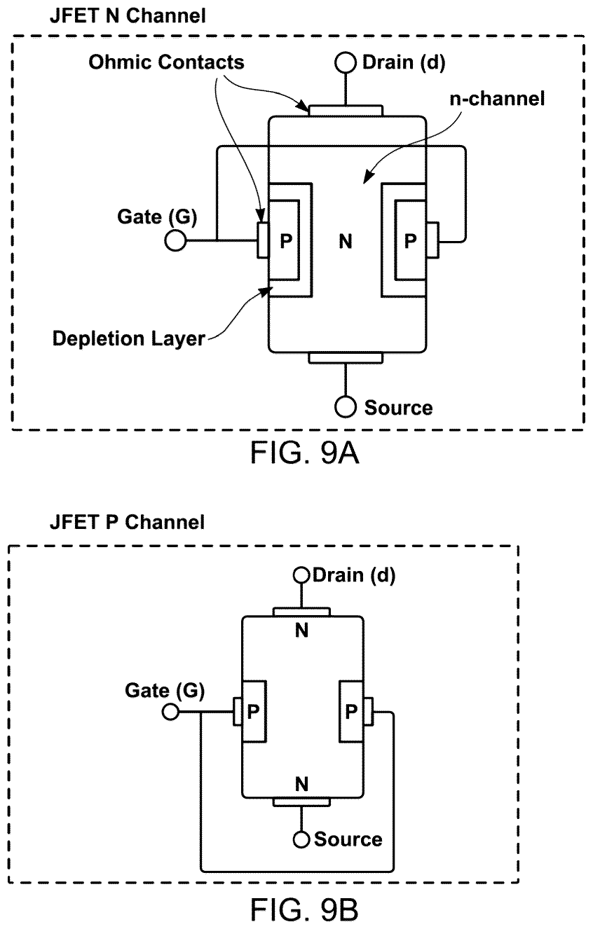

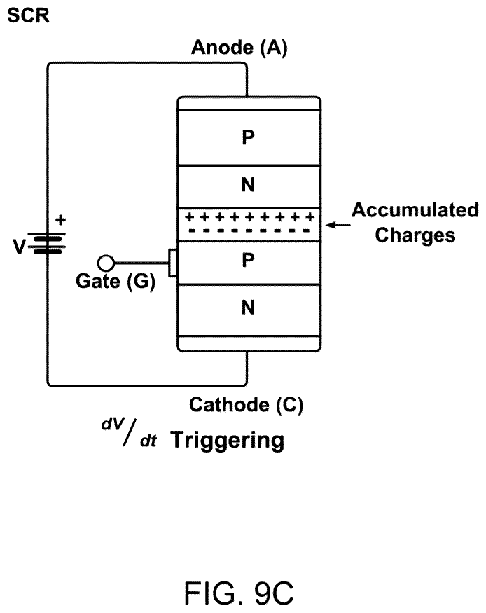

FIGS. 9a and 9b are perspective views of a programmable JFET N-Channel Junction Field Effect Transistor and P-Channel Junction Field Effect Transistor circuit component to be used as a fast switch between solar, battery and utility modes for the present invention.

There are two types of JFETs: N-channel JFET and P-channel JFET. The N channel JFET controls the flow of current through electrons, while the P channel JFET depends on the movement of the holes where the electrons are absent. The gate terminal plays a major role in conducting current and controls the electron flow from source to drain. JFETs are also useful in switching circuits because they can be used as voltage-controlled resistors.

The n-channel junction field effect transistor is a semiconductor device that has three terminals: gate, source, and drain. It is made up of an N-type semiconductor thin bar material. The majority of charge carriers for n-type are electrons. This forms a channel between source and drain. When a negative voltage is applied to the gate terminal, it creates an electric field across the insulating material between the gate and the channel.

Whenever a negative voltage in the gate increases, the electric field also increases, narrowing the channel and decreasing the current flow between the source and drain. To control the flow of electrons and to be used in applications such as voltage regulator, impedance switches, etc., the high input of this n channel JFET can be used.

The p-channel junction field effect transistor is a semiconductor device that has three terminals: gate, source, and drain. It is made up of a semiconductor p-type thin bar material. The majority of carriers are holes in the p type. This forms a channel between source and drain.

When a positive voltage is applied to the gate terminal, it creates an electric field across the insulating material between the gate and the channel. Whenever a positive voltage in the gate increases, the electric field also increases, narrowing the channel and decreasing the current flow between the source and drain. In applications such as amplifiers, switches, and signal processing, the high input of this p channel impedance JFET can be used to control the flow of holes.

FIG. 9c. is a perspective view of the programmable Silicone Transistor (SCR) circuit component to be used as a fast switch between solar, battery and utility modes for the present invention.

A silicon-controlled rectifier (SCR) is a four-layer solid-state current-controlling device, With three modes of operation depending upon the biasing given to it:
1. Forward blocking mode (off state)
2. Forward conduction mode (on state)
3. Reverse blocking mode (off state)

A static transfer switch uses power semiconductors such as Silicon-controlled rectifiers (SCRs) to transfer a load between two sources. Because there are no mechanical moving parts, the transfer can be completed rapidly, perhaps within a quarter-cycle of the power frequency. Static transfer switches can be used where reliable and independent sources of power are available, and it is necessary to protect the load from even a few power frequency cycles interruption time, or from any surges or sags in the prime power source.

A silicon-controlled switch (SCS) behaves nearly the same way as an SCR; but there are a few differences: Unlike an SCR, an SCS switches off when a positive voltage/input current is applied to another anode gate lead. Unlike an SCR, an SCS can also be triggered into conduction when a negative voltage/output current is applied to that same lead. SCSs are useful in practically all circuits that need a switch that turns on/off through two distinct control pulses. This includes power-switching circuits, logic circuits, lamp drivers, counters, etc. Inverse-parallel connected Silicon Controlled Rectifiers (SCR) can be used to switch AC circuits.

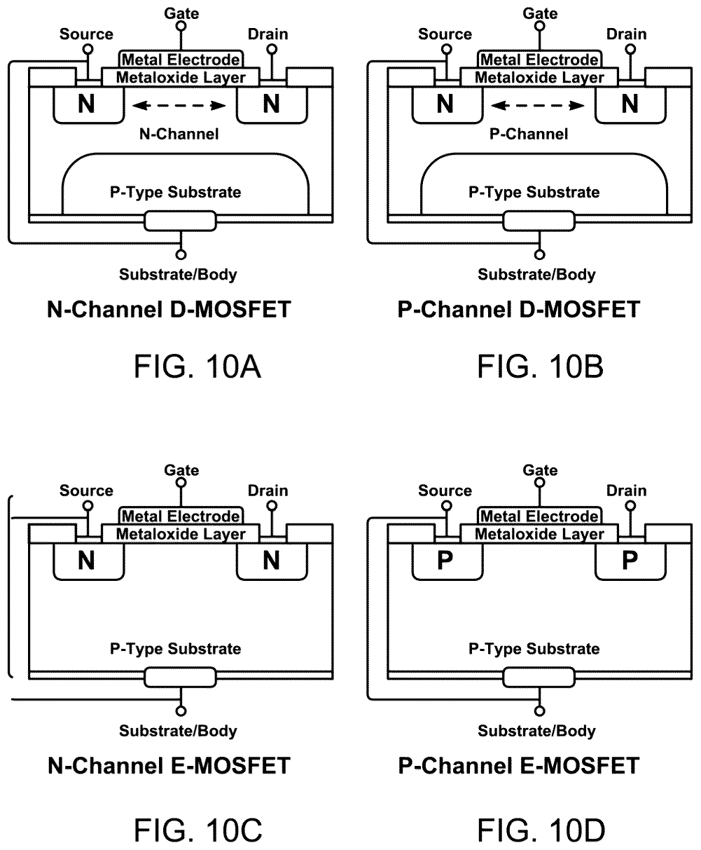

FIGS. 10a, 10b, 10c and 10d are perspective views of a programmable MOSFET (NMOS) circuit component to be used as a fast switch between solar, battery and utility modes for the present invention.

MOSFET is a type of transistor in which conductivity depends upon the semiconductor channel across the drain and source terminal. This semiconductor channel may be p-channel or n-channel depending upon the configuration of the MOSFET.

A MOSFET consists of three terminals-drain, source and gate. By applying some voltage across gate and source, there forms an inversion layer or a channel between the drain and source if the voltage applied is the threshold voltage. The threshold voltage is defined as the minimum required voltage for the conduction of current). If the applied voltage is less than the threshold voltage, no channel is formed. This situation is called the Cutoff region (OFF). And after a certain level of voltage, the current becomes constant in the MOSFET. This condition is called the saturation point. MOSFET is a voltage-controlled device so the thickness of channel and the amount of current depends upon the voltage applied across gate and source. If more voltage is applied, the width of channel increases and more amount of current able to flow through the device.

N-channel Enhancement Type MOSFET have to make gate terminal more +ve, hence +ve charges will accumulate in the gate and will attract −ve charges in the body. Electrons will drift towards the surface and the region near the surface will become less p type. +ve charges are pushed down. So, the above region will become n type and thus a channel is formed.

When increasing the voltage between gate and source, then the width of channels will increase. And if the voltage is more than a particular voltage, the channel width is sufficient to allow flow of current and is called Threshold voltage. And the resultant current is known as drain current.

A p-channel enhancement type MOSFET is a type of MOSFET which works by applying +ve voltage to the device. It operates according to the voltage applied to the gate terminal.

Working of N-channel Depletion Type MOSFET. Here, the channel is present from the beginning. By applying a +ve voltage it creates a depletion region, reducing the charge carriers and results in decrement of current. In this design the MOSFET is generally ON.

Working of P-channel Depletion Type MOSFET. The current between drain and source is controlled by the gate voltage but there is a difference. Channel is present from the beginning when no voltage is applied. Source and drain terminals are made with p type semiconductors and so is the channel. Majority charge carriers are the holes. Applying a −ve voltage, the channel depletes and hence the width of the channel decreases and hence the resistance increases decreasing the amount of current flow. It is a voltage-controlled resistor and the n and source terminal is made up of n-type semiconductor.

The MOSFET is used in digital complementary metal-oxide-semiconductor (CMOS) logic, which uses p-and n-channel MOSFETs as building blocks. Overheating is a major concern in integrated circuits since ever more transistors are packed into ever smaller chips. CMOS logic reduces power consumption because no current flows (ideally), and thus no power is consumed, except when the inputs to logic gates are being switched. CMOS accomplishes this current reduction by complementing every nMOSFET with a pMOSFET and connecting both gates and both drains together. A high voltage on the gates will cause the nMOSFET to conduct and the pMOSFET not to conduct and a low voltage on the gates causes the reverse. During the switching time as the voltage goes from one state to another, both MOSFETs will conduct briefly. This arrangement greatly reduces power consumption and heat generation.

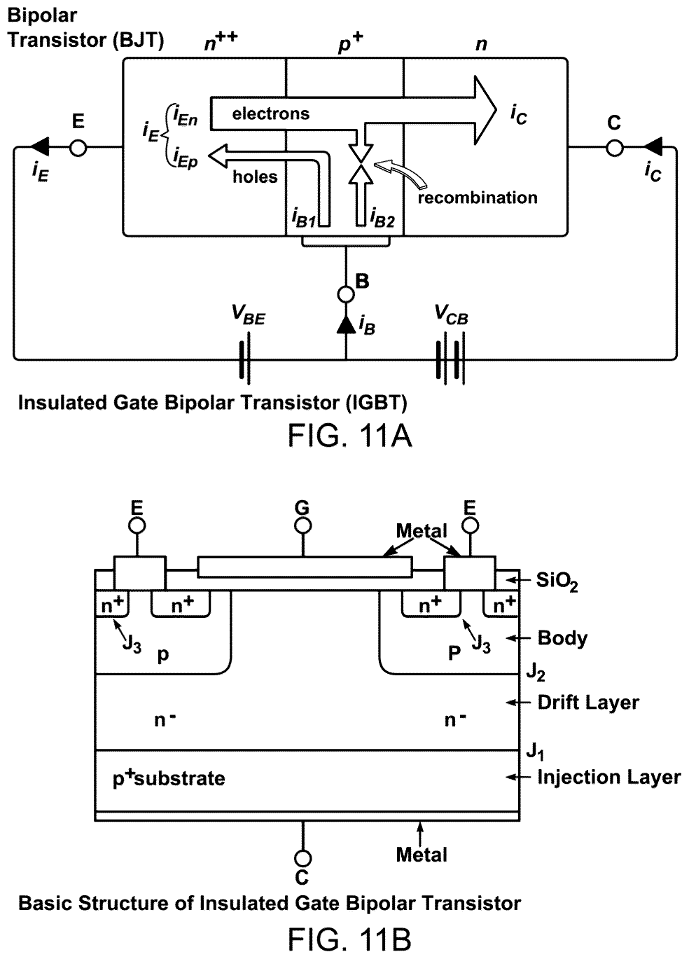

FIG. 11a is a perspective view of the programmable Bipolar Junction Transistor (BJT) circuit component to be used as a fast switch between solar, battery and utility modes for the present invention.

A BJT is made of three alternating layers of P-type and N-type semiconductor materials having two PN junctions. It has 3 terminals i.e. Emitter, Base, and Collector. Each terminal is connected with each layer of the transistor.

The base is the middle layer sandwiched between Emitter and Collector. The base is the most lightly doped layer of all. The emitter and collector are both heavily doped with the emitter comparatively heavily doped than the collector.

BJT is a current controlled device. It means it uses the input current at its base terminal to control the output current or collector current. By connecting the base-collector junction in reverse and base-emitter junction in forward bias allows the flow of current between emitter and collector. This current is directly proportional to the base current.

Since its base-emitter junction or input is forward biased, the input impedance is very low. The output impedance is very high due to collector-emitter reverse bias. Therefore, BJT has a very high gain.

The BJT has an NPN Transistor that is formed by the combination of two N-type materials and one P-type material. The P-region is sandwiched between N-regions. The three terminals Collector, Base and Emitter each rise from N. P and N regions, respectively.

The majority charge carriers are electrons while the minority charge carriers are holes. Applying current I_{B} to the base terminal allows current I_{C} from the collector to the emitter. The current is directly proportional to the base current. While the total emitter current I_{E} is the sum of both base I_{b} and collector current I_{C}.

The BJT has a PNP transistor that is formed by the combination of two P-layers and one N-layer. The thin N-layer is sandwiched between two thick P-layers. The middle N-layer is called base while the surrounding two layers are called collector and emitter.

FIG. 11b is a perspective view of the programmable Insulated Gate Bipolar Transistor (IGBT) circuit component to be used as a fast switch between solar, battery and utility modes for the present invention.

The IGBT is a bipolar transistor, also comprised of three components: an emitter, collector, and gate. IGBTs have the high-current and low-saturation-voltage input capabilities of bipolar transistors with the output characteristics of MOSFET. Unlike MOSFETs, IGBTs are currently controlled, producing a magnetic field rather than an electric field and a minority carrier dominant current. IGBTs have multiple layers of P and N substrate which give them the advantage of handling high voltages as compared to the MOSFET. These extra layers come with the disadvantage of lower switching speeds, however, innovations in IGBT technology have allowed these transistors to have switching speeds comparable to MOSFET. Like MOSFETs, the specific applications of IGBTs depend on voltage and switching conditions.

The IGBT Transistor takes the best parts of these two types of common transistors, the high input impedance and high switching speeds of a MOSFET with the low saturation voltage of a bipolar transistor and combines them together to produce another type of transistor switching device that is capable of handling large collector-emitter currents with virtually zero gate current drive.

The IGBT combines the insulated gate technology of the MOSFET with the output performance characteristics of a conventional bipolar transistor. The result of this hybrid combination is that the “IGBT Transistor” has the output switching and conduction characteristics of a bipolar transistor but is voltage-controlled like a MOSFET.

IGBTs are mainly used in power electronics applications, such as inverters, converters and power supplies, where the demands of the solid-state switching device are not fully met by power bipolars and power MOSFETs. High-current and high-voltage bipolars are available, but their switching speeds are slow, while power MOSFETs may have higher switching speeds, but high-voltage and high-current devices are expensive and hard to achieve.

The advantage gained by the insulated gate bipolar transistor device over a BJT or MOSFET is that it offers greater power gain than the standard bipolar type transistor combined with the higher voltage operation and lower input losses of the MOSFET.

Another candidate for the fast switching needed for the present invention is the TRIAC which resembles an SCR in that both act as electrically controlled switches. Unlike an SCR, a TRIAC can pass current in either direction. Thus, TRIACs are particularly useful for AC applications. TRIACs have three leads: a gate lead and two conducting leads, referred to as MT1 and MT2. If no current/voltage is applied to the gate lead, the TRIAC switches off. On the other hand, if the trigger voltage is applied to the gate lead, the TRIAC switches on.

In mode 1, when the MT2 terminal is positive regarding the MT1 Terminal, then the ongoing stream will be toward P1-N1-P2-N2. In the meantime, the intersection among the layers like P1-N1 and P2-N2 is associated in forward one-sided while the Intersection among N1-P2 is associated backward one-sided. Once the positive signal is given to the door terminal then the intersection among P2-N2 is associated in forward one-sided and breakdown occurs

In Mode 2, the MT2 terminal is positive, and the door signal is negative, then the progression of current will be likewise to the main method of P1-N1-P2-N2, but here the intersection among the P2-N2 can be associated in forward one-sided and the ongoing transporters are added into the P2 layer,

In Mode 3, the MT2 terminal is positive, and negative sign can be given toward the door terminal, then the progression of current will be toward P2-N1-P2-N2. In the meantime, the intersection among the two layers like P2-N1 and P1-N4 is associated in forward one-sided while the intersection among the layers N1-P1 is associated backward one-sided. Hence, this TRIAC will work inside the locale of adversely one-sided.

In Mode 4, the MT2 terminal is negative, and the entryway terminal is enacted through a positive sign then the intersection among P2-N2 is associated in sending one-sided and the transporters of current are added, in this way the TRIAC is turned ON. Normally, the TRIAC doesn't work in that frame of mind because of the downside that it ought not be utilized for high di/dt circuits.

The awareness of TRIAC setting off by utilizing modes 2 and 3 is high. The negative entryway sign can be utilized in the event of a minor enacting limit. The initiating of mode 1 is delicate when contrasted with different modes like 2 and 3, but it utilizes a positive entryway signal for enacting. The most often utilized modes are 2 and 3.

A TRIAC has three terminals M1, M2, and door, Using a TRIAC light burden, and a stock voltage are associated in series. At the point when supply is ON at positive cycle then the ongoing courses through light, resistors, and DIAC (gave setting off beats are given at pin 1 of optocoupler bringing about pin 4 and 6 beginnings leading) entryway and arrives at the inventory and afterward just light gleams for that half cycle straightforwardly through the M2 and M1 terminal of the TRIAC.

While this invention has been described as having a preferred design, the present invention can be further modified within the spirit and scope of this disclosure. The application is therefore intended to cover any variations, uses, or adaptations of the invention using its general principles. Further, this application is intended to cover such departures from the present disclosure that arise from known or customary practice and the art to which this invention pertains, and which fall within the limits of the appended claims.

1. An innovative electrical panel configured to switch between solar/battery mode and power grid mode:
a main input power source;
a solar input power source or a battery input power source or any combination thereof;
the innovative electrical panel configured to utilize one or more standard circuit breakers one or more custom designed circuit breakers with wireless technology, or any combination thereof;
one or more fast switching components that are configured to alternate one or more circuit breakers between the main input power source and the solar, a battery or any combination thereof, input power source;
a neutral line and connection bar;
a grounding line and connection bar;
a CPU or a microprocessor, the CPU or microprocessor configured to control the one or more fast switch components; and
one or more wireless transceivers.

2. The innovative electrical panel configured to switch between solar/battery mode and power grid mode as recited in claim 1, wherein the electrical panel is configured to automatically switches to the grid-tied mode when it senses a voltage or current/amperage limit programming into the electrical panel that the solar/battery voltage limit is decreasing below the voltage or current limit.

3. The innovative electrical panel configured to switch between solar/battery mode and power grid mode as recited in claim 1, wherein included is a programming mode of the CPU or microprocessor configured to set voltage, timing schedule or current/amperage limits, or any combination thereof.

4. The innovative electrical panel configured to switch between solar/battery mode and power grid mode as recited in claim 1, wherein the one or more wireless communication transceivers are configured to communicate via:
a wireless network based on an IEEE 802.11 standard;
an infrared light transmission scheme;
a low power and long-range chirp spread modulation technology;
a network that utilizes the low power and long-range chirp spread modulation technology;
a wireless technology that transmits over a very narrow spectrum;
an Internet Protocol (IPv6) utilizing a sub-1 GHz frequency;
a network based on a star topology network with master and slave devices described in the EN 13757 standard, which comprises operating modes S, T, R, and C (868 MHz), F (433 MHz), and W (169 MHz);
a narrowband internet of things (IoT) is a low-power wide-area network radio technology standard developed by 3GPP for cellular network devices and services;
a differential binary phase-shift keying and Gaussian frequency shift keying over the short-range device band of 868 MHz in Europe, and the Industrial, Scientific and Medical radio band of 902 MHz in the US;
an interoperable implementation of an IEEE 802.16 family of wireless-networks standards;
a network that utilizes a smart speaker technology, provides cloud connectivity for an internet of things (IoT) and utilizes low-bandwidth and long-range connectivity;
a third-generation wireless mobile telecommunications technology (3G);
a fourth-generation wireless mobile telecommunications technology(4G);
a fifth-generation wireless mobile telecommunications technology (5G);
a sixth-generation wireless mobile telecommunications technology (6G); or
a seventh-generation wireless mobile telecommunications technology (7G), or any combination thereof.

5. The innovative electrical panel configured to switch between solar/battery mode and power grid mode as recited in claim 1, wherein included is a transfer switch.

6. The innovative electrical panel configured to switch between solar/battery mode and power grid mode as recited in claim 4, wherein the programming mode can be conducted remotely utilizing a cell phone, a smart phone, mobile phone, or a remote computer.

7. The innovative electrical panel configured to switch between solar/battery mode and power grid mode as recited in claim 1, wherein the electrical component comprises a MOSFET technology, a JFET technology, a BIT technology, a IGBT Technology, a SCR technology, or a TRIAC technology, or any combination thereof.

8. The innovative electrical panel configured to switch between solar/battery mode and power grid mode as recited in claim 1, wherein the CPU or microprocessor has instructions to comprise a SUB mode, a SBU mode or a USB mode.

9. The innovative electrical panel configured to switch between solar/battery mode and power grid mode as recited in claim 8, wherein the JFET technology includes an N-Channel or a P-Channel technology.

10. The innovative electrical panel configured to switch between solar/battery mode and power grid mode as recited in claim 8, wherein the MOSFET technology includes N-Channel D-MOSFET, P-Channel D-MOSFET, N-Channel E-MOSFET, or P-Channel E-MOSFET.

11. An innovative electrical panel configured to switch between solar/battery mode and power grid mode:
a main input power source;
a solar input power source, a battery input power source or any combination thereof;
the innovative electrical panel configured to utilize one or more standard circuit breakers one or more custom designed circuit breakers with wireless technology, or any combination thereof;
one or more fast switching components that are configured to alternate one or more circuit breakers between the main input power source and the solar, a battery or any combination thereof, input power source;
a neutral line and connection bar;
a grounding line and connection bar;
a CPU or a microprocessor, the CPU or microprocessor configured to control the one or more fast switch components.

12. The innovative electrical panel configured to switch between solar/battery mode and power grid mode as recited in claim 11, wherein the electrical panel is configured to automatically switches to the grid-tied mode when it senses a voltage or current/amperage limit programming into the electrical panel that the solar/battery voltage limit is decreasing below the voltage or current limit.

13. The innovative electrical panel configured to switch between solar/battery mode and power grid mode as recited in claim 11, wherein included is a programming mode of the CPU or microprocessor configured to set voltage, timing schedule, or current/amperage limits, or any combination thereof.

14. The innovative electrical panel configured to switch between solar/battery mode and power grid mode as recited in claim 11, wherein included is a transfer switch.

15. The innovative electrical panel configured to switch between solar/battery mode and power grid mode as recited in claim 4, wherein the programming mode can be conducted remotely utilizing a cell phone, a smart phone, mobile phone, or a remote computer.

16. The innovative electrical panel configured to switch between solar/battery mode and power grid mode as recited in claim 11, wherein the electrical component comprises a MOSFET technology, a JFET technology, a BJT technology, a IGBT Technology, a SCR technology, or a TRIAC technology, or any combination thereof.

17. The innovative electrical panel configured to switch between solar/battery mode and power grid mode as recited in claim 16, wherein the JFET technology includes an N-Channel or a P-Channel technology.

18. The innovative electrical panel configured to switch between solar/battery mode and power grid mode as recited in claim 16, wherein the MOSFET technology includes N-Channel D-MOSFET, P-Channel D-MOSFET, N-Channel E-MOSFET, or P-Channel E-MOSFET.

19. The innovative electrical panel configured to switch between solar/battery mode and power grid mode as recited in claim 11, wherein the CPU or microprocessor has instructions to comprise a SUB mode, a SBU mode or a USB mode.
